(19) United States
(12) Patent Application Publication
(10) Pub. No.: US 2007/0110118 A1
(43) Pub. Date: May 17, 2007

(54) Vertical external cavity surface emitting laser capable of recycling pump beam

(75) Inventors: Ki-sung Kim, Hwaseong-si (KR); Taek Kim, Seongnam-si (KR)

Correspondence Address: BUCHANAN, INGERSOLL & ROONEY PC, POST OFFICE BOX 1404, ALEXANDRIA, VA, 22313-1404, US

(73) Assignee: SAMSUNG ELECTRONICS CO., LTD., Suwon-si (KR)

(21) Appl. No.: 11/448,840

(22) Filed: Jun. 8, 2006

(30) Foreign Application Priority Data
Nov. 16, 2005 (KR) 10-2005-0109635

(51) Int. Cl. H01S 3/091; H01S 3/08; H01S 3/092

(52) U.S. Cl. 372/99; 372/92; 372/70

(57) ABSTRACT

A vertical external cavity surface emitting laser (VECSEL) using end pumping in which a pumping beam is recycled to increase pumping beam absorption is provided. The VECSEL comprises: an active layer for generating and emitting signal light with a predetermined wavelength; an external mirror separated from and facing a top surface of the active layer and adapted to transmit a first portion of the signal light generated by the active layer and to reflect a second portion of the signal light to the active layer; a pump laser for emitting a pumping beam to excite the active layer toward the top surface of the active layer; and a double band mirror (DBM) positioned beneath the lower surface of the active layer and adapted to reflect both the signal light generated by the active layer and a portion of the pumping beam which is not absorbed in the active layer.

### CROSS-REFERENCE TO RELATED PATENT APPLICATION

This application claims the benefit of Korean Patent Application No. 10-2005-0109635, filed on Nov. 16, 2005 in the Korean Intellectual Property Office, the disclosure of which is incorporated herein in its entirety by reference.

### BACKGROUND OF THE DISCLOSURE

1. Field of the Disclosure

The present disclosure relates to a vertical external cavity surface emitting laser (VECSEL), and more particularly, to a VECSEL using front pumping in which a pumping beam is recycled to increase the pumping beam absorption by an active layer.

2. Description of the Related Art

A vertical cavity surface emitting laser (VCSEL) oscillates in a single longitudinal mode of very narrow spectrum and emits a beam having a small radiation angle. VCSELs can be easily integrated with other devices, but the output power of the VCSEL is low.

A vertical external cavity surface emitting laser (VECSEL) is a high output laser with the above-described advantages of the VCSEL. The VECSEL has an external mirror instead of an upper mirror, resulting in an increased gain region, and can thus output several to dozens of watts of light.

FIG. 1 is a schematic view of a VECSEL 10. The VECSEL 10 is a front pumping laser in which light is pumped by a pump laser 15 which is disposed obliquely in the front of the VECSEL 10. As illustrated in FIG. 1, the VECSEL 10 includes a heat sink 11, a Distributed Bragg Reflector (DBR) 13 and an active layer 14 sequentially stacked on the heat sink 11, an external mirror 17 that faces the active layer 14 and is separated a predetermined distance from the active layer 14, and the pump laser 15 placed obliquely toward the top surface of the active layer 14. A heat spreader 12 may be further formed on the top surface of the active layer 14 to spread the heat generated by the active layer 14, and a second harmonic generation (SHG) crystal 18 which doubles the frequency of the light output may be interposed between the active layer 14 and the external mirror 17. Also, the VECSEL further includes a collimating lens 16 that collimates the pumping beam emitted from the pump laser 15. The active layer 14 may have a multiple quantum well structure having a resonant periodic gain (RPG) structure and is excited by the pumping beam to emit light with a predetermined wavelength. The pump laser 15 emits a pumping beam having a shorter wavelength than the wavelength of the light emitted from the active layer 14 to excite the active layer 14.

In the above described configuration, a pumping beam with a relatively short wavelength λ₁ emitted from the pump laser 15 is incident on the active layer 14, and the active layer 14 is excited to emit light with a predetermined wavelength of λ₂. The emitted light is reflected repetitively between the DBR layer 13 and the external mirror 17 through the active layer 14. Thus, a portion of the light amplified in the active layer 14 is output to the outside via the external mirror 17. When the SHG crystal 18 is interposed between the active layer 14 and the external mirror 17, for example, light in the infrared region emitted from the active layer 14 is converted into visible light and then output.

FIG. 2 is a schematic view of a conventional VCSEL 20 using end pumping. In the VECSEL 10 using front pumping illustrated in FIG. 1, the incident surface of the pumping beam in the active layer 14 and the emission surface of the output light are the same. That is, a pumping beam is incident through the top surface of the active layer and the output light is emitted through the top surface of the active layer 14. On the other hand, as illustrated in FIG. 2, in the VECSEL 20 using end pumping, a pumping beam is incident through the lower surface of the active layer 23 and the output light is emitted through the top surface of the active layer 23. For example, a DBR layer 22 and an active layer 23 are stacked sequentially on a light transmissive heat spreader 21 which is formed of diamond or silicon carbide (SiC), and a pump laser 24 faces the active layer 23 with the light transmissive heat spreader 21 interposed therebetween. Accordingly, a pumping beam emitted from the pump laser 24 passes through the light transmissive heat spreader 21 and is incident on the lower surface of the active layer 23.

However, in the conventional VECSEL, a pumping beam emitted from the pump laser may not be completely absorbed by the active layer and a portion of the pumping beam is dispersed by the heat sink or passes through the active layer and then emitted. In the VECSELs using front pumping, a portion of the pumping beam which is not completely absorbed by the active layer passes through the DBR layer and is wasted. In the VECSEL 10 of FIG. 1, for example, when the active layer 14 emits signal light having a wavelength of 1060 nm, a pump laser with a wavelength of 808 nm is generally used. As illustrated in FIG. 3, the DBR 13, which is designed to have maximum reflectivity at a wavelength of 1060 nm, has minimum reflectivity at a wavelength of 808 nm. Accordingly, in the conventional VECSELs using front pumping, a pumping beam passing through the active layer also passes the DBR layer and enters the heat sink.

In the VECSELs using end pumping, a portion of the pumping beam which is not absorbed by the active layer is emitted through the top surface of the active layer. Accordingly, conventional VECSELs cannot efficiently use the energy of the pumping beam, and thus have low efficiency.

### SUMMARY OF THE DISCLOSURE

The present disclosure may provide a vertical external cavity surface emitting laser (VECSEL) using front pumping in which a pumping beam emitted from a pump laser is recycled to increase pumping beam absorption by an active layer.

According to an aspect of the present invention, there may be provided a vertical external cavity surface emitting laser (VECSEL) comprising: an active layer for generating and emitting signal light with a predetermined wavelength; an external mirror that is separated from and faces a top surface of the active layer and is adapted to transmit a first portion of the signal light generated by the active layer and to reflect a second portion of the signal light to the active layer, the first portion of the signal light being the output of the VECSEL; a pump laser for emitting a pumping beam toward the top surface of the active layer, the pumping beam being adapted to excite the active layer; and a double band mirror (DBM) positioned beneath the lower surface of the active layer and adapted to reflect both the signal light generated by the active layer and a portion of the pumping beam which is not absorbed in the active layer.

The DBM may have the maximum reflectivity with respect to the wavelengths of the signal light and the pumping beam. The DBM may have a reflectivity of at least 30% with respect to the wavelengths of the signal light and the pumping beam.

The signal light reflected by the DBM may resonate between the DBM and the external mirror and the portion of the pumping beam reflected by the DBM may be absorbed by the active layer.

The DBM may be a semiconductor Distributed Bragg Reflector (DBR) having a multi-layer structure comprising a semiconductor layer H with a first refractive index, a semiconductor layer L with a second refractive index, and a spacer layer S stacked repetitively in a predetermined sequence, and wherein the first refractive index is higher than the second refractive index. The spacer layer may be formed of the same material as the material composing the semiconductor layer with the first refractive index or the semiconductor layer with the second refractive index.

The thickness T of the spacer layer may satisfy (λ/4)×M×0.5≦T≦(λ/4)×M×1.5, wherein M is a positive integer, and λ is the average of the wavelengths of the signal light and the pumping beam.

The multi-layer structure of the DBM may be [(HL)^{D}S]^{N} or [(LH)^{D}S]^{N}, wherein D and N are natural numbers which are greater than 1 and smaller than 100.

The DBM may be a semiconductor DBR having a multi-layer structure comprising a semiconductor layer H with a first refractive index, a semiconductor layer L with a second refractive index stacked repetitively in a predetermined sequence, wherein the first refractive index is higher than the second refractive index.

The multi-layer structure of the DBM may be [(2H)^{D1}(LH)^{D2}(2L)^{D3}(LH)^{D4}]^{N} or [(2L)^{D1}(HL)^{D2}(2H)^{D3}(HL)^{D4}]^{N}, wherein D1, D2, D3, D4, and N are natural numbers which are greater than 1 and smaller than 100.

The multi-layer structure of the DBM may be [(LH)^{D1}(HL)^{D2}]^{N} or [(HL)^{D1}(LH)^{D2}]^{N}, wherein D1, D2, and N are natural numbers which are greater than 1 and smaller than 100.

The thickness of the semiconductor layer with the first refractive index and the semiconductor layer with the second refractive index may be λ/4, wherein λ is the average of the wavelengths of the signal light and the pumping beam.

The semiconductor layer with the first refractive index may be composed of AlₓGa₁₋ₓAs (0≦x<1) and the semiconductor layer with the second refractive index may be composed of Al_{y}Ga_{1-y}As (0<y≦1), wherein y is greater than x.

The active layer may comprise a plurality of quantum well layers and barrier layers interposed between the quantum well layers, and each of the quantum well layers is disposed in an anti-node of a standing wave which is generated by the signal light resonating between the external mirror and the DBM.

A heat sink disposed on the lower surface of the DBM and adapted to radiate the heat generated by the active layer may be further included.

A light transmissive heat spreader disposed on the top surface of the active layer and adapted to cool the active layer may be further included. The light transmissive heat spreader may be formed of a material selected from the group consisting of diamond, silicon carbide (SiC), aluminum nitride (AlN), and gallium nitride (GaN).

Also, a second harmonic generation (SHG) crystal that doubles the frequency of the signal light emitted from the active layer and may be included between the active layer and the external mirror.

### BRIEF DESCRIPTION OF THE DRAWINGS

The above and other features and advantages of the present invention will be described in detailed exemplary embodiments thereof with reference to the attached drawings in which:

FIG. 1 is a schematic view of a conventional vertical external cavity surface emitting laser (VECSEL) using front pumping;

FIG. 2 is a schematic view of a conventional VECSEL using end pumping;

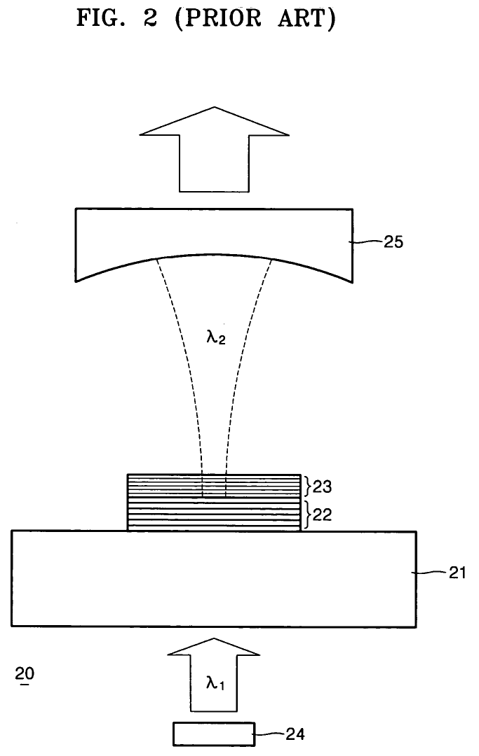

FIG. 3 is a graph illustrating the reflectivity of a Distributed Bragg Reflector (DBR) used in conventional VECSELs according to wavelength;

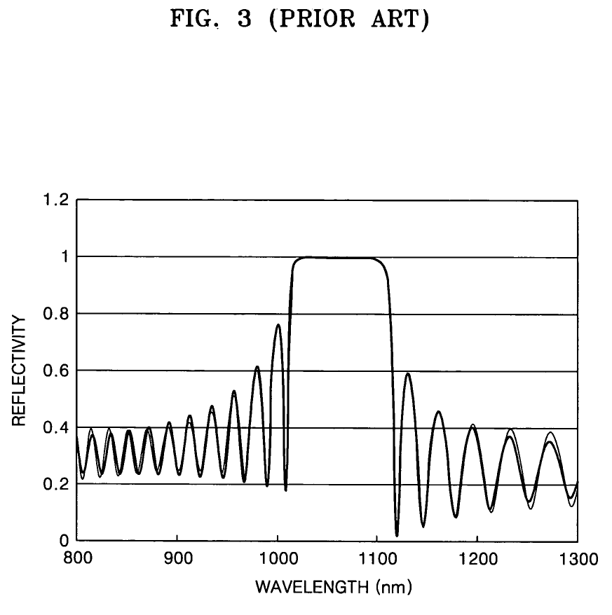

FIG. 4 is a schematic view of a VECSEL in which a pumping beam can be recycled using a double band reflector according to an embodiment of the present invention;

FIG. 5 is a schematic view of an active layer and a double band reflector of a VECSEL according to an embodiment of the present invention;

FIG. 6 is a graph illustrating an increase in pumping beam absorption by recycling the pumping beam in a VECSEL according to an embodiment of the present invention;

FIG. 7 is a graph illustrating the reflectivity of a double band reflector according to the wavelength according to an embodiment of the present invention;

FIG. 8 is a graph illustrating an increase in output of the VECSEL of FIG. 7;

FIG. 9 a graph illustrating the reflectivity of a double band reflector according to the wavelength according to another embodiment of the present invention; and

FIG. 10 is a graph illustrating an increase in the output of the VECSEL of FIG. 9.

### DETAILED DESCRIPTION OF THE PREFERRED EMBODIMENTS

The present invention will now be described more fully with reference to the accompanying drawings, in which exemplary embodiments of the invention are shown.

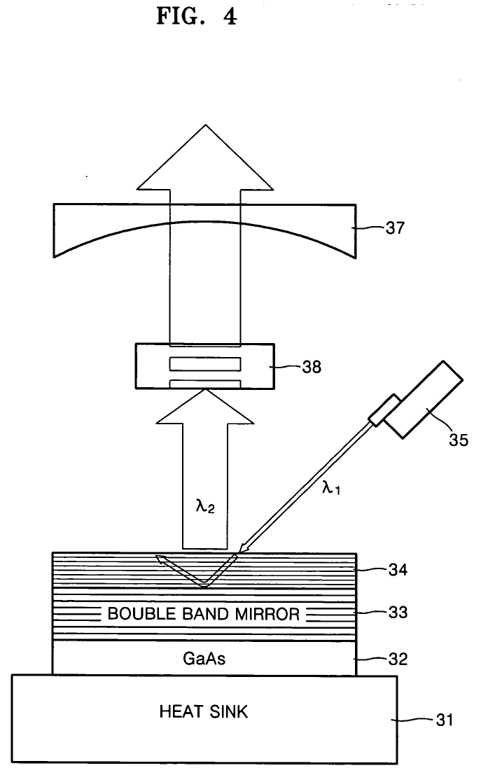

FIG. 4 is a schematic view of a vertical external cavity surface emitting laser (VECSEL) 30 according to an embodiment of the present invention. As illustrated in FIG. 4, the VECSEL 30 includes an active layer 34 emitting signal light with a predetermined wavelength λ₂, an external mirror 37 separated from and facing a top surface of the active layer 34, a pump laser 37 emitting a pumping beam λ₁ toward the top surface of the active layer 34 to excite the active layer 34, and a double band mirror (DBM) 33 contacting the lower surface of the active layer 34 and reflecting both the signal light generated by the active layer 34 and the portion of the pumping beam which is not absorbed by the active layer 34. The DBM 33 and the active layer 34 can be sequentially grown and formed on a GaAs substrate 32. The external mirror 37 reflects most of the incident signal light generated by the active layer 34 and transmits a portion of the signal light to the outside.

A second harmonic generation (SHG) crystal 38 which doubles the frequency of the signal light emitted from the active layer 34 may be further included between the active layer 34 and the external mirror 37. When the SHG crystal 38 is interposed between the active layer 34 and the external mirror 37, the light in the infrared region emitted from the active layer 34 can be converted into a visible light and then output.

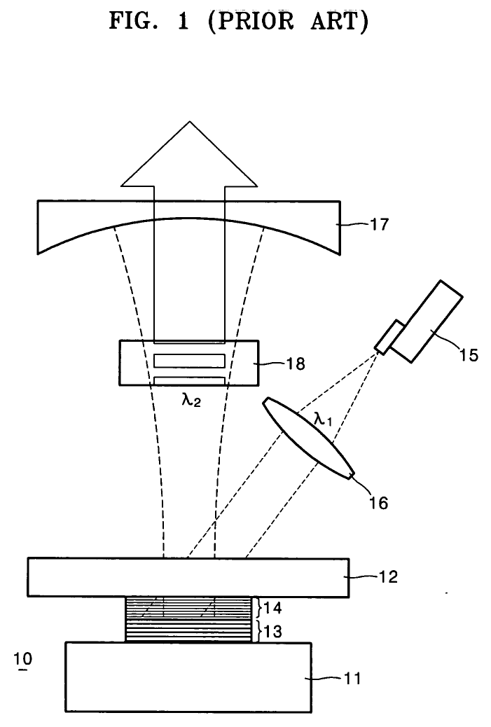

Also, although not shown in FIG. 4, like in FIG. 1, a heat spreader radiating the heat generated by the active layer 34 may be further included on a top surface of the active layer 34. The heat spreader can be light transmissive so that the pumping beam emitted from the pump laser 35 and the signal light generated by the active layer 34 can pass through the heat spreader. The light transmissive heat spreader may be composed of diamond, silicon carbide (SiC), aluminum nitride (AlN), or gallium nitride (GaN).

Also, as illustrated in FIG. 4, a heat sink 31 may be disposed below the DBM 33 to radiate the heat generated by the active layer 34 to the outside.

Accordingly, the VECSEL 30 according to an embodiment of the present invention has almost the same structure as the VECSEL 10 in FIG. 1, except that the VECSEL 30 includes a DBM 33 which reflects not only the signal light generated by the active layer 34 but also the pumping beam generated by the pump laser 35. That is, in the conventional VECSEL 10 using front pumping, a Distributed Bragg Reflector (DBR) 13 reflects only the signal light generated by the active layer 14 and transmits the pumping beam generated by the pump laser 15. Accordingly, a portion of the pumping beam that is not absorbed in the active layer cannot be recycled and is discarded. However, in the VECSEL 30 with the DBM 33 according an embodiment of the present invention, the portion of the pumping beam transmitted through the active layer 34 is reflected and is incident again on the active layer 34 as illustrated in FIG. 4. Therefore, the portion of the pumping beam that is not initially absorbed by the active layer 34 can still excite the active layer 34.

Also, the DBM 33 can reflect the signal light generated by the active layer 34 so that the signal light generated by the active layer 34 can resonate between the DBM 33 and the external mirror 37. For this, the DBM 33 may have maximum reflectivity with respect to wavelengths λ₁ and λ₂ of the pumping beam and the signal light. For example, the reflectivity of the DBM 33 may be at least 30% or more with respect to wavelengths of the signal light and the pumping beam.

In general, a reflector cannot have high reflectivity with respect to every wavelength but instead has a high reflectivity with respect to a particular wavelength. The DBM 33 according to the present embodiment has a high reflectivity with respect to two wavelengths, that is, the wavelength λ₂ of the signal light and the wavelength λ₁ of the pumping beam. The DBM 33 may be, for example, a double band semiconductor DBR including a plurality of semiconductor layers having different refractive indexes. Specifically, the DBM 33 may include semiconductor layers H having a high refractive index and semiconductor layers L having a low refractive index sequentially stacked in a predetermined sequence or semiconductor layers H having a high refractive index, semiconductor layers L having a low refractive index sequentially, and spacer layers S stacked in a predetermined sequence. The semiconductor layer H having a high refractive index is formed of AlₓGa₁₋ₓAs (0≦x<1), for example, GaAs (that is, x=0). The semiconductor layer L having a low refractive index is formed of Al_{y}Ga_{1-y}As (0<y≦1), for example, AlAs (y=1). Generally, the refractive index of a composition including Al, Ga and As increases as the composition ratio of Ga increases, and the refractive index decreases as the composition ratio of Al increases. Therefore, y is greater than x. Also, the spacer layer S is formed of the same material as the semiconductor layer H or the semiconductor layer L. For example, when the semiconductor layer H with a high refractive index is GaAs and the semiconductor layer L with a low refractive index is AlAs, the spacer layer S may be one of GaAs and AlAs.

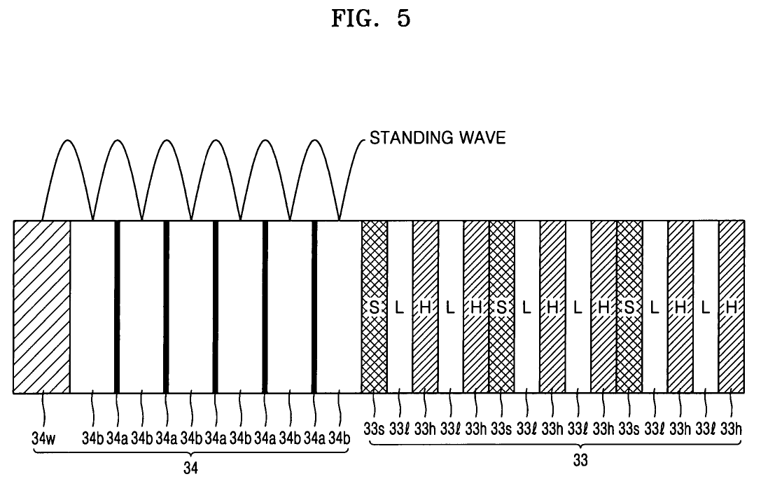

FIG. 5 is a schematic view of multi-layer structures of the active layer 34 and the double band mirror 33 of the VECSEL 30 according to an embodiment of the present invention. First, as is known in the art, the active layer 34 has a resonant periodic gain (RPG) structure formed of a plurality of quantum wells 34a with barriers 34b interposed between these quantum wells 34a. A window layer 34w may form the top portion of the active layer 34 to protect the quantum wells [34q] 34a. In order to obtain a gain, each quantum well [34q] 34a is disposed in an anti-node of a standing wave that is generated by the signal light resonating between the external mirror 37 and the DBM 33. Accordingly, the distance between the quantum wells [34q] 34a is equal to the wavelength of the signal light generated by the active layer 34. The pumping beam incident on the active layer 34 is mainly absorbed by the quantum wells [34q] 34a. The quantum wells [34q] 34a absorb the pumping beam to emit signal light, and for the active layer 34 to be excited by the pumping beam, the wavelength λ₁ of the pumping beam may be shorter than the wavelength λ₂ of the signal light. For example, when the wavelength λ₂ of the signal light is 920 nm or 1060 nm in the infrared region, the wavelength λ₁ of the pumping beam may be approximately 880 nm. Such a pumping beam does not need to resonate, and thus the quantum wells [34q] 34a do not have to be disposed in the anti-nodes of the pumping beam.

The DBM 33 of FIG. 5 has a repeating structure including the semiconductor layer H, the semiconductor layer L, the semiconductor layer H, the semiconductor layer L, and the spacer layer S stacked sequentially on the substrate 32. The DBM 33 in FIG. 5 includes three sets of this repeating structure. The structure of the DBM 33 illustrated in FIG. 5 can be expressed as [(HL)²S]³.

The stack sequence of the DBM layer 33 can be optimally selected according to the wavelength of the light to be reflected by performing a simulation, and as the number of stacked layers included in the DBM layer 33 increases, the reflectivity for the desired wavelength increases. For example, when the wavelength of a pumping beam is 808 nm, and the wavelength of a signal light is 920 nm or 1060 nm, the DBM 33 may have a multi-layer structure of [(HL)^{D}S]^{N}, [(2H)^{D1}(LH)^{D2}(2L)^{D3}(LH)^{D4}]^{N} or [(LH)^{D1}(HL)^{D2}]^{N}. In such a configuration, the positions of the semiconductor layer H and the semiconductor layer L are interchangeable. That is, the DBM 33 may have a multi-layer structure of [(LH)^{D}S]^{N}, [(2L)^{D1}(HL)^{D2} (2H)^{D3}(HL)^{D4}] or [(HL)^{D1}(LH)^{D2}]^{N}. Here, D, D1, D2, D3, D4, and N are natural numbers greater than 1 and smaller than 100. A desired reflectivity for a desired wavelength can be obtained by controlling the value of D, D1, D2, D3, D4, and N.

In such a configuration, the thickness of the semiconductor layer H and the semiconductor layer L may be λ/4 where λ is the average of the wavelength λ₁ of the signal light and the wavelength λ₂ of the pumping beam, that is, λ=(λ₁+λ₂)/2. The thickness T of the spacer layer S may vary within 50% of λ/4 multiplied by a positive integer. The thickness T of the spacer S may be expressed as (λ/4)×M×0.5≦T≦(λ/4)×M×1.5 where M is a positive integer. The thickness of each layer can be selected according to the wavelength of the light to be reflected by performing a simulation.

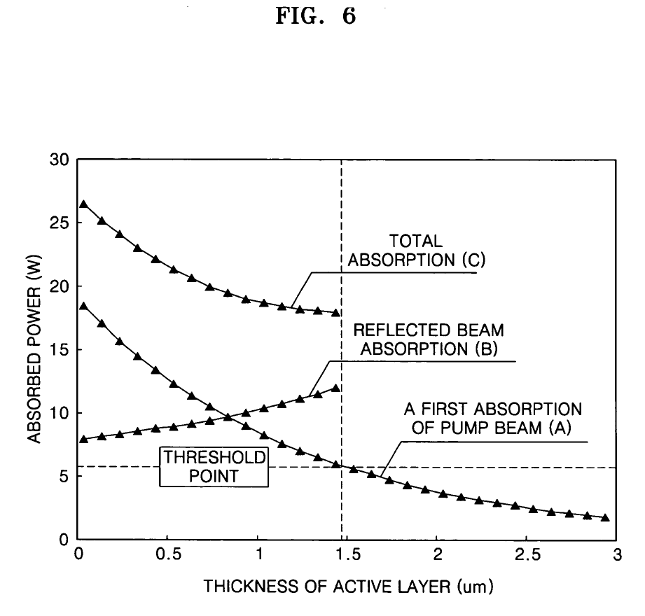

By using the DBM 33 to reflect the signal light and the pumping beam, the portion of the pumping beam which is not absorbed by the active layer 34 can be recycled. FIG. 6 is a graph illustrating the increase in the pumping beam absorption obtained by recycling of the pumping beam in the active layer 34 using the DBM 33 in the VECSEL 30 according to an embodiment of the present invention. As illustrated in graph A in FIG. 6, the pumping beam which is directly incident from the pump laser 35 enters through the surface of the active layer 34 and is attenuated as it proceeds through the active layer 34. Accordingly, the amount of the pumping beam absorbed decreases as the pumping beam passes through the active layer 34. Consequently, the power at the depth of 1.5 μm from the surface of the active layer 34 is less than a threshold power, and thus the active layer 34 cannot emit signal light from a depth greater than 1.5 μm. Accordingly, the thickness of the active layer 34 may be approximately 1.5 μm. The portion of the pumping beam which is not absorbed by the active layer 34 is emitted through the lower surface of the active layer 34. The pumping beam is reflected by the DBM 33 formed on the lower surface of the active layer 34 and again passes through on the active layer 34. As illustrated in graph B in FIG. 6, the reflected pumping beam is absorbed by the active layer 34. As a result, the overall absorption of the pumping beam in the active layer 34 increases as illustrated in graph C in FIG. 6, and the deviation of the pumping beam absorption according to the depth in the active layer 34 is reduced as well. Accordingly, as the overall density of carriers in the active layer 34 is increased, the output of the laser device is increased. Also, the output of the VECSEL 30 according to the depth is relatively uniform, thus improving the characteristic of the laser device.

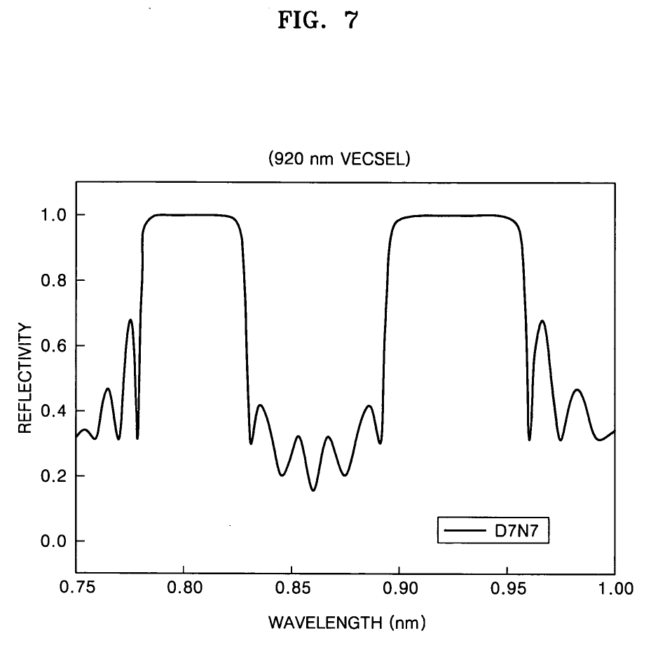

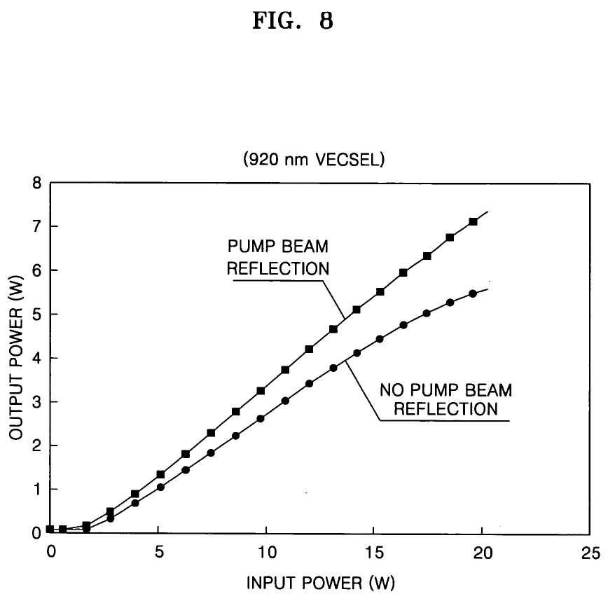

FIGS. 7 and 8 are graphs respectively illustrating the reflectivity of the DBM 33 according to wavelength and the increase in the output of the VECSEL illustrated in FIG. 7 according to an embodiment of the present invention in which the wavelength of the pumping beam is 808 nm and the wavelength of the signal light is 920 nm. In the present embodiment, the DBM 33 has the structural formula [(HL)^{D}S]^{N} where, D=7, N=7, the semiconductor layer H is composed of Al_{0.2}Ga_{0.8}As and has a thickness of 617.5 Å, and the semiconductor layer L is composed of AlAs and has a thickness of 714.7 Å, and the spacer layer S is composed of Al_{0.2}Ga_{0.8}As and has a thickness of 617.5 Å.

As illustrated in FIG. 7, the DBM 33 of the present embodiment has a reflectivity of almost 100% at the wavelengths of 808 nm and 920 nm. Also, as illustrated in FIG. 8, when the pumping beam is recycled according to the present embodiment, the output power is increased compared to the VECSEL in which a pumping beam is not recycled. For example, when the input power is 20 W, the output may increase by more than 30% over the output of the conventional VECSEL. Also, the input and the output of the VECSEL can have a more linear relationship than in the conventional VECSEL.

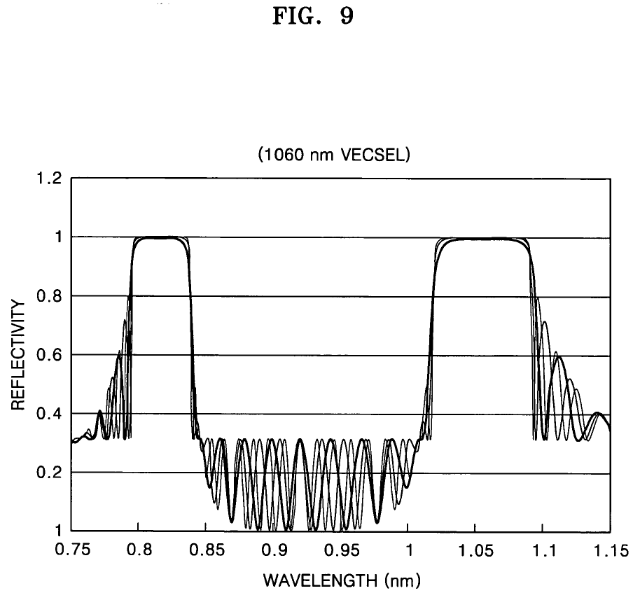

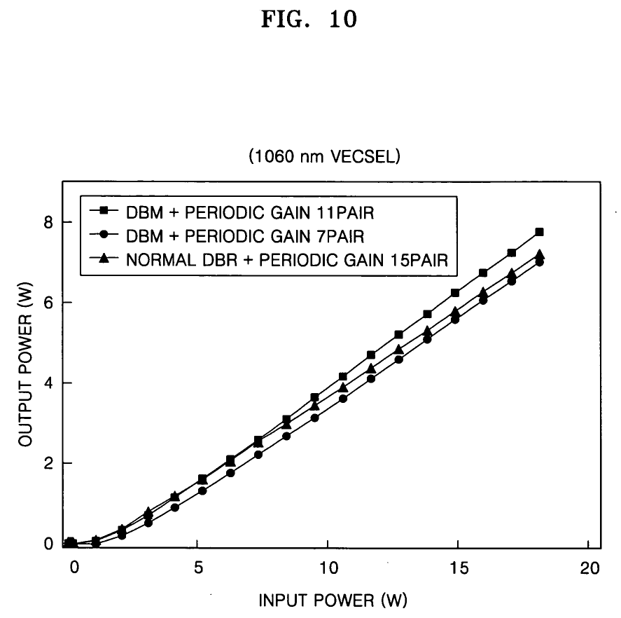

FIGS. 9 and 10 are graphs respectively illustrating reflectivity of the DBM 33 according to wavelength and the increase in the output of the VECSEL illustrated in FIG. 9 according to an embodiment of the present invention in which the wavelength of the pumping beam is 808 nm and the wavelength of the signal light is 1060 nm. In the present embodiment, the DBM 33 has the structural formula [(LH)^{D1}(HL)^{D2}]^{N} where, D1=4, D2=4, N=9, the semiconductor layer H is composed of Al_{0.2}Ga_{0.8}As and has a thickness of 668 Å, and the semiconductor layer L is composed of AlAs and has a thickness of 769 Å.

As illustrated in FIG. 9, the DBM 33 in the present embodiment has reflectivity of almost 100% at the wavelengths of 808 nm and 1060 nm. As illustrated in FIG. 10, when the pumping beam is recycled according to the present embodiment, the output power is increased compared to the VECSEL in which a pumping beam is not recycled. For example, the output of the conventional laser with 15 quantum wells that does not recycle pumping beam and the output of a laser according to an embodiment of the present invention with 7 quantum wells that does recycle a pumping beam are almost equal. Also, when a laser according to an embodiment of the present invention in which the pumping beam is recycled includes 11 quantum wells, the output is 10% higher than the output of the conventional laser with 15 quantum wells in which a pumping beam is not recycled.

As described above, in the VECSELs according to certain embodiments of the present invention, a portion of a pumping beam that is not absorbed by the active layer and thus emitted can be recycled by the DBM. As a result, the usage efficiency of the pumping beam is increased such that a laser device with a great output can be provided. Also, laser devices according to certain embodiments of the present invention with a thinner active layer and less power consumption can be provided. The output variation of the VECSEL has a larger slope compared to the conventional VECSEL and the input and the output of the VECSEL can have a more linear relationship.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A vertical external cavity surface emitting laser (VECSEL) comprising:
an active layer for generating and emitting signal light with a predetermined wavelength;
an external mirror that is separated from and faces a top surface of the active layer and is adapted to transmit a first portion of the signal light generated by the active layer and to reflect a second portion of the signal light to the active layer, the first portion of the signal light being the output of the VECSEL;
a pump laser for emitting a pumping beam toward the top surface of the active layer, the pumping beam being adapted to excite the active layer; and
a double band mirror (DBM) positioned beneath the lower surface of the active layer and adapted to reflect both the signal light generated by the active layer and a portion of the pumping beam which is not absorbed in the active layer.

2. The VECSEL of claim 1, wherein a DBM has the maximum reflectivity with respect to the wavelengths of the signal light and the pumping beam.

3. The VECSEL of claim 2, wherein the DBM has a reflectivity of at least 30% with respect to the wavelengths of the signal light and the pumping beam.

4. The VECSEL of claim 3, wherein the signal light reflected by the DBM resonates between the DBM and the external mirror and the portion of the pumping beam reflected by the DBM is absorbed by the active layer.

5. The VECSEL of claim 3, wherein the DBM is a semiconductor Distributed Bragg Reflector (DBR) having a multi-layer structure comprising a semiconductor layer H with a first refractive index, a semiconductor layer L with a second refractive index, and a spacer layer S stacked repetitively in a predetermined sequence, and wherein the first refractive index is higher than the second refractive index.

6. The VECSEL of claim 5, wherein the spacer layer is formed of the same material as the material composing the semiconductor layer with the first refractive index or the semiconductor layer with the second refractive index.

7. The VECSEL of claim 6, wherein the thickness T of the spacer layer satisfies (λ/4)×M×0.5≦T≦(λ/4)×M×1.5, wherein M is a positive integer, and λ is the average of the wavelengths of the signal light and the pumping beam.

8. The VECSEL of claim 6, wherein the multi-layer structure of the DBM is [(HL)^{D}S]^{N} or [(LH)^{D}S]^{N}, wherein D and N are natural numbers which are greater than 1 and smaller than 100.

9. The VECSEL of claim 3, wherein the DBM is a semiconductor DBR having a multi-layer structure comprising a semiconductor layer H with a first refractive index, a semiconductor layer L with a second refractive index stacked repetitively in a predetermined sequence, and wherein the first refractive index is higher than the second refractive index.

10. The VECSEL of claim 9, wherein the multi-layer structure of the DBM is [(2H)^{D1}(LH)^{D2}(2L)^{D3}(LH)^{D4}]^{N} or [(2L)^{D1}(HL)^{D2}(2H)^{D3}(HL)^{D4}]^{N}, wherein D1, D2, D3, D4, and N are natural numbers which are greater than 1 and smaller than 100.

11. The VECSEL of claim 9, wherein the multi-layer structure of the DBM is [(LH)^{D1}(HL)^{D2}]^{N} or [(HL)^{D1}(LH)^{D2}]^{N}, wherein D1, D2, and N are natural numbers which are greater than 1 and smaller than 100.

12. The VECSEL of claim 5, wherein the thickness of the semiconductor layer with the first refractive index and the semiconductor layer with the second refractive index is λ/4, wherein λ is the average of the wavelengths of the signal light and the pumping beam.

13. The VECSEL of claim 5, wherein the semiconductor layer with the first refractive index is composed of AlₓGa₁₋ₓAs (0≦x<1) and the semiconductor layer with the second refractive index is composed of Al_{y}Ga_{1-y}As (0<y≦1), wherein y is greater than x.

14. The VECSEL of claim 1, wherein the active layer comprises a plurality of quantum well layers and barrier layers interposed between the quantum well layers, and each of the quantum well layers is disposed in an anti-node of a standing wave which is generated by the signal light resonating between the external mirror and the DBM.

15. The VECSEL of claim 1, further comprising a heat sink disposed on the lower surface of the DBM and adapted to radiate the heat generated by the active layer.

16. The VECSEL of claim 1, further comprising a light transmissive heat spreader disposed on the top surface of the active layer and adapted to cool the active layer.

17. The VECSEL of claim 16, wherein the light transmissive heat spreader is formed of a material selected from the group consisting of diamond, silicon carbide (SiC), aluminum nitride (AlN), and gallium nitride (GaN).

18. The VECSEL of claim 1, further comprising a second harmonic generation (SHG) crystal that doubles the frequency of the signal light emitted from the active layer and is interposed between the active layer and the external mirror.
